(19) United States
(12) Patent Application Publication
(10) Pub. No.: US 2012/0198491 A1
(43) Pub. Date: Aug. 2, 2012

(54) TRANSPARENTLY VERIFIYING USER IDENTITY DURING AN E-COMMERCE SESSION USING SET-TOP BOX INTERACTION BEHAVIOR

(75) Inventors: BRIAN M. O'CONNELL, RTP, NC (US); KEITH R. WALKER, AUSTIN, TX (US)

(73) Assignee: INTERNATIONAL BUSINESS MACHINES CORPORATION, ARMONK, NY (US)

(21) Appl. No.: 13/444,465

(22) Filed: Apr. 11, 2012

Related U.S. Application Data
(63) Continuation-in-part of application No. 11/279,186, filed on Apr. 10, 2006, now abandoned.
Application No. 11/279,186 is a continuation-in-part of application No. 12/126,117, filed on May 23, 2008.

(51) Int. Cl. H04N 21/47

(52) U.S. Cl. 725/30

(57) ABSTRACT

A set-top box device can detect a user interaction associated with a remote control proximate to the set-top box device. The set-top box device can store the user interaction within a storage device as user interaction data. The set-top box device can convey the user interaction data to a remotely located server. The set-top box device can receive a response from the remotely located server indicating that a behavior pattern in the interaction data is substantially equivalent to a behavior pattern in previously stored interaction data of a behavior profile. The response can verify the identity of the user.

### CROSS-REFERENCE TO RELATED APPLICATIONS

This application is a continuation-in-part of U.S. patent application Ser. No. 11/279,186, filed Apr. 10, 2006 and U.S. patent application Ser. No. 12/126,117 filed on May 23, 2008.

### TECHNICAL FIELD

The present invention relates to the field of user authentication and, more particularly, to transparently verifying user identity during an e-commerce session using set-top box interaction behavior.

### BACKGROUND

A set-top box (STB) can be a device which connects to a television and an external source of a signal, turning the signal into content which can be displayed on the television screen (e.g., or other display) device. A cable converter box can be a type of set-top box which can transpose (e.g., convert) any available channels from a cable television service to an analog Radio Frequency (RF) signal on a single channel (e.g., channel 3 or 4). The cable converter box can allow a television set which is not “cable ready” to receive cable channels. While later televisions include the converter built-in, the existence of premium television (e.g., pay per view) and the advent of digital cable have continued the need for various forms of set-top boxes for cable television reception. Set-top boxes are frequently controlled via a remote control which allows a viewer to interact with the set-top box. For example, the remote control can be used to change the channel the set-top box is presenting.

Set-top boxes are becoming increasingly utilized in electronic commerce (e.g., e-commerce) transactions. For example, many cable subscribers often purchase products through the use of a Web browser on the television. Traditional approaches to protect businesses and users from e-commerce fraud rely on positively validating the user in one or more transparent ways. One traditional method that can be utilized is user verification via keyboard/mouse interaction with a device. For example, a user often interacts with a Web site in similar way from session to session. That is, user habits can be tracked and a profile can be created to uniquely verify a user. Methods have been disclosed for mouse/keyboard interactions, but due to the disparate nature of the interaction styles, those methods are not applicable to set-top box remote controls. That is, set-top box remote controls lack mouse/keyboard functionality, rendering traditional methods inapplicable.

One known solution can be to require a security code (3 or 4 digit non-imprinted number on credit card) with every purchase, but this provides no protection when the code is entered during a “phishing” process. Another solution can be to require operator “call back,” but phone numbers can be quickly setup and taken down with no audit trail (e.g., Voice over IP). Further, it can be expensive to employ personnel to make live phone calls, and customers must be near a phone to receive a call back. For Internet-consumable goods, customers are not treated to the instant satisfaction of their purchase, thus lowering overall customer satisfaction. Lastly, requiring that the user fully validate his or her credentials with every purchase can result in an extra step for the user and can lower overall customer satisfaction.

### SUMMARY

In at least one embodiment, there is a method for verifying a user based on data of interactions between the user and a set-top box. In the method, a set-top box device detects a user interaction associated with a remote control proximate to the set-top box device. The set-top box device stores the user interaction within a storage device as user interaction data. The set-top box device conveys the user interaction data to a remotely located server. The set-top box device receives a response from the remotely located server indicating that a behavior pattern in the interaction data is substantially equivalent to a behavior pattern in previously stored interaction data of a behavior profile. The response can verify the identity of the user.

In at least one embodiment, there is a computer system for verifying a user based on data of interactions between the user and a set-top box. The computer system can include one or more processors, one or more computer-readable memories and one or more computer-readable tangible storage devices. The computer system can include program instructions, stored on at least one of the one or more storage devices for execution by at least one of the one or more processors via at least one of the one or more memories, to detect a user interaction between a user and a remote control device associated with a set-top box executing a graphical user interface. The graphical user interface is an interface of an e-commerce session. The graphical user interface is associated with a browser session associated with a Web server. The computer system can include program instructions to store the user interaction within a storage device as user interaction data. The computer system can include program instructions to verify or refute a user identity using a two factor authentication process by evaluating a behavior pattern in the user interaction data against a behavior pattern in previously stored interaction data contained within a behavior profile specific to the user.

In at least one embodiment, there is a computer program product for verifying a user based on data of interactions between the user and a set-top box. The computer program product can include one or more computer-readable tangible storage devices. The computer program produce can include program instructions, stored on at least one of the one or more storage devices, to detect user interaction data associated with a remote control proximate to the set-top box device. The computer program produce can include program instructions, stored on at least one of the one or more storage devices, to store the user interaction data within a storage device as user interaction data. The computer program produce can include program instructions, stored on at least one of the one or more storage devices, to convey the user interaction data to a remotely located server. The computer program produce can include program instructions, stored on at least one of the one or more storage devices, to receive a response from the remotely located server indicating that a behavior pattern in the interaction data is substantially equivalent to a behavior pattern in previously stored interaction data of a behavior profile. The response can verify the identity of the user.

### BRIEF DESCRIPTION OF THE SEVERAL VIEWS OF THE DRAWINGS

FIG. 1 is a schematic diagram illustrating a set of processes transparently verifying user identity during an e-commerce session based on set-top box remote control interaction behavior in accordance with an embodiment of the inventive arrangements disclosed herein.

FIG. 2 is a schematic diagram illustrating a method for transparently verifying user identity during an e-commerce session based on set-top box remote control interaction behavior in accordance with an embodiment of the inventive arrangements disclosed herein.

FIG. 3 is a schematic diagram illustrating a system for transparently verifying user identity during an e-commerce session based on set-top box remote control interaction behavior in accordance with an embodiment of the inventive arrangements disclosed herein.

FIG. 4 is a schematic diagram illustrating an exemplary computing device and an embodiment for a set-top box for transparently verifying user identity during an e-commerce session based on set-top box remote control interaction behavior in accordance with an embodiment of the inventive arrangements disclosed herein.

### DETAILED DESCRIPTION

Embodiments of the present invention provide a solution for transparently verifying user identity during an e-commerce session based on set-top box interaction behavior. In embodiments of the present invention, set-top box interaction behavior data can be unobtrusively communicated to an authentication entity to verify the identity of a returning set-top box user based upon previous user interaction(s) with the set-top box. Embodiments of the present invention can be a component of a secondary authentication method in a “Two Factor” authentication system. Disclosed embodiments of methods cannot, by themselves, authenticate the set-top box user. However, when used in conjunction with a primary authentication method, such as an account number and Personal Identification Number (PIN), disclosed embodiments of methods can result in increased authentication strength.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium (also referable to as a storage device or a computer-readable, tangible storage device) may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

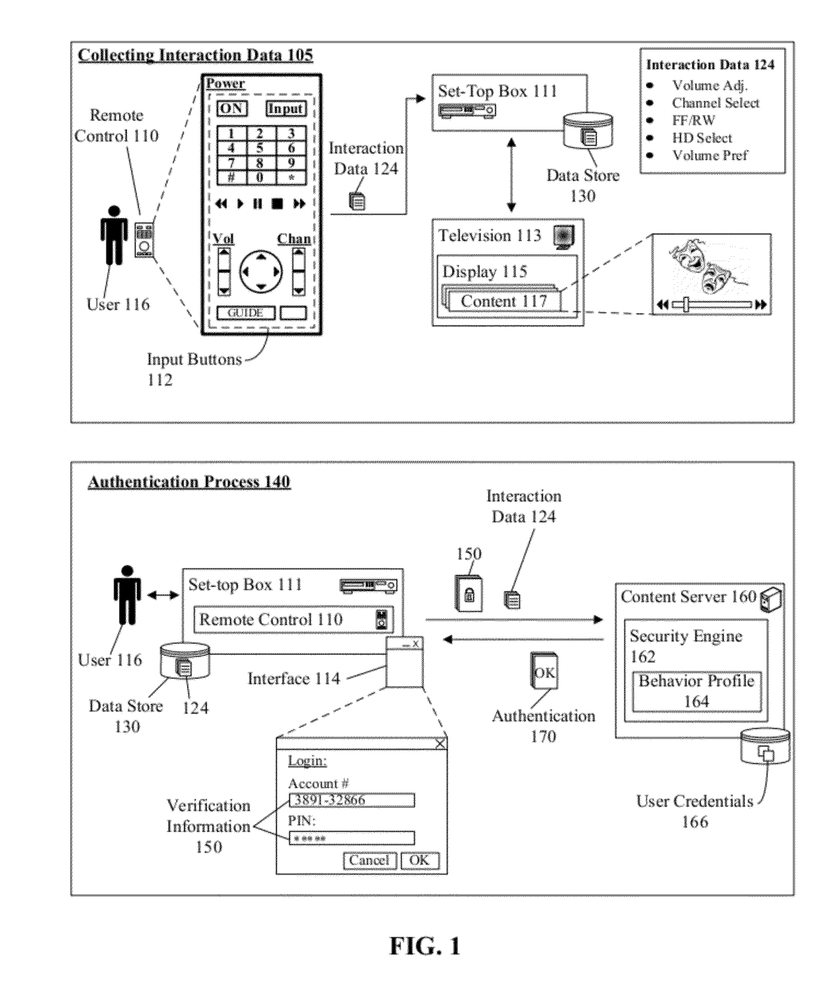

FIG. 1 is a schematic diagram illustrating a set of processes 105, 140 transparently verifying user identity during an e-commerce session based on set-top box remote control interaction behavior in accordance with an embodiment of the inventive arrangements disclosed herein. Processes 105, 140 can be performed in the context of method 200 and system 300. In process 105, a user 116 can interact with a set-top box 111 via a remote control 110. Remote control 110 can be an electronic device permitting the operating of set-top box 111 from a proximate distance. For example, remote control 110 can allow user 116 sitting on a couch within a room to interact with set-top box 111 on the far side of the room. As user 116 interacts with buttons 112, interaction data 124 can be collected and persisted within data store 130. That is, interaction data 124 (e.g., volume adjustment, channel selection) for the remote 110 can be collected. Collected data (e.g., data 124) can be submitted during authentication process 140 to verify user identity. For example, when user 116 uses remote control 110 to select to purchase a pay-per-view event, set-top box 111 can utilize data 124 to verify user identity prior to payment submission. In process 140, user provided verification information 150 can be communicated with interaction data 124 to authenticate user 116. That is, data 124 can be utilized within a “two factor” authentication process to uniquely verify user 116. It should be appreciated that the solution can be an active or a passive authentication solution. For example, embodiments of the present invention can be utilized to continuously (e.g., periodically) confirm a user identity throughout an e-commerce session.

An e-commerce session can be a semi-permanent interactive information interchange between a set-top box and a provider entity (e.g., content server 160, product/service provider). Process 105 can be performed at any time during an e-commerce session. That is, data 124 can be collected during anonymous browsing, at login time, post-login, and the like. Set-top box 111 can receive data 124 in response to user 116 selecting an input button of input buttons 112. For example, remote control 110 can communicate a command code(s) assigned to the selected input button to set-top box 111. Set-top box 111 (e.g., processor 322) can process the command code(s). An e-commerce session can be associated with online activities including, but not limited to, electronic funds transfer, online transaction processing, electronic data interchange (EDI), social networking, entertainment activities (e.g., viewing streaming media), and the like.

As used herein, interaction data 124 can be behavioral information associated with usage of remote control 110 with set-top box 111. Data 124 can include, but is not limited to, volume adjustment style, channel select behavior, fast forward/rewind interactions, high definition selection preferences, volume preferences, and the like.

In one embodiment, set-top box 111 can capture interaction data 124 in real-time or near real-time as user 116 interacts with set-top box 111 via remote control 110. Each time user 116 selects an input button of input buttons 112, set-top box 111 can receive an appropriate command (e.g., command code) from remote control 110. Program code (e.g., program code 334) executing within set-top box 111 can capture and decode the appropriate command (e.g., command code). For example, program code (e.g., program code 334) can decode can decode the command using a command table. In response to selection of a command that can be utilized for interaction data, a trigger can cause program code to be executed to monitor subsequent button presses (e.g., interaction). For example, in response to user 116 selecting a volume up control (e.g., a volume up button of input buttons 112), the program code can monitor each subsequent volume up command received. Aggregating the frequency, timing, and other relevant attributes of user 116 interaction, data 124 can be formed and stored within data store 130.

Volume adjustment style can include two or more common types of interactions for associated with set-top box 111 and/or television 113. For example, user 116 can utilize volume buttons on remote control 110 to adjust the volume of content 117. Volume adjustment style can include, but is not limited to, stepwise adjustment and jump adjustment. In the stepwise adjustment, user 116 can repeatedly press a volume adjustment button on remote control 110 to reach a desired volume level. In the jump adjustment style, user 116 can hold a volume button on remote control 110 down continuously until the volume reaches a desired level. It should be noted that a small number of step wise adjustments can occur in different use cases, and the differentiation between the methods can be noted during large changes in the volume setting.

Channel selection can be associated with choosing one or more content channels associated with a content provider. Content of the one or more channels associated with the content provider can be presented on display 115 of television 113. Channel selection methods can include three or more common types of channel choosing. Channel selection methods can include, but are not limited to, content guide-based selection, channel increment/decrement selection, and direct tuning selection. In the guide-based selection method, user 116 can select a channel by first invoking an electronic programming guide (e.g., content guide) using remote control 110, navigating through the guide using remote control 110, and selecting an appropriate channel using remote control 110. In the increment/decrement method, user 116 can select a channel by using channel up/down buttons on remote control 110 to increase or decrease the channel number by a single channel through each selection. In the direct tuning selection method, user 116 can input a channel number using a keypad on remote control 110. It should be noted that the user profile (e.g., behavior profile 164) for selection methodologies can span multiple tuning methods. For example, user 116 can directly tune to several favorite channels, but use the guide for other channels. The user preference for selecting common channels (e.g., favorite channels) and uncommon channels can be detected and stored within behavior profile 164. In one instance, common and uncommon channel selection methods can be discerned by total viewing time for each channel.

Fast forward/rewind (FF/RW) actions (e.g., fast forwarding through content 117) can include two or more methods including smooth FF/RW or jump FF/RW methods. In the smooth FF/RW method, user 116 can press the fast forward button or rewind button once on remote control 110 and cancel the fast forward or rewind operation using another button on remote control 110, such as the play button or pause button, on remote control 110. In the jump method, user 116 can press a “seek” or “jump” button on remote control 110 to move forward or backward at defined intervals (e.g., thirty seconds). Similar to the volume adjustment method, the user style can be defined over large changes in content location and/or minor adjustments can be ignored as both styles can be employed.

High definition (HD) channel selection can be a content selection associated with content quality. When content 117 is available in standard definition and high definition, user 116 can use remote control 110 to optionally select to view either. For example, user 116 can have a preference for high definition while another user (not shown) can prefer standard definition. In one instance, the HD channel selection method can track the frequency of high definition and standard definition content selection. It should be noted this method can be applied to streaming television (TV), such that user 116 purchases the high definition version of a program when the option is available.

Since users can have varying preferences for volume levels, this preference can be leveraged to assist in developing behavior profile 164. For example, one user can prefer the volume to be louder than a different user watching the same content 117. The user 116 baseline volume selection can be noted and associated with behavior profile 164. The baseline volume level can be associated with time of day, content 117 type, and the like. For example, user 116 can have different baseline volume levels at midnight than at noon. It should be noted that for all volume methods, even if set-top box 111 cannot control the volume, set-top box 111 can intercept the volume control commands destined for another device (Television, Stereo Receiver, etc).

In one embodiment, interaction data 124 can include data regarding proximate remote controllers associated with surrounding devices. In the instance, set-top box 111 can detect codes (e.g., infrared codes) which are transmitted by the proximate remote controllers and are not intended for set-top box 111. For example, set-top box 111 can detect that IR codes for a television are transmitted along with IR codes for a proximate receiver. Over time, set-top box 111 can learn common proximate devices functioning at the same time as set-top box 111. In this manner, set-top box 111 can protect against theft and/or misusage. For example, if set-top box 111 is stolen and placed into a new location, set-top box 111 can detect that unknown IR codes are being transmitted which can trigger a security action to be performed (e.g., prompting for a second factor authentication). In one embodiment, when a new proximate device is detected, set-top box 111 can learn that a device has been added. In the embodiment, after an initial two factor successful authentication, the proximate device can be added to set-top box 111's list of authorized proximate devices.

In one instance, interaction data 124 can include habitual mannerism data of habitual mannerisms in interacting with input buttons 112. In this instance, data 124 can include data of commonly selected buttons, non-selected buttons, and the like. For example, data 124 can indicate whether user 116 utilizes an “exit” button or a “guide” button to leave a content guide.

In one embodiment, timing between presses of two or more of input buttons 112 can be computed from latency between the button presses to identify usage patterns unique to user 116. In the embodiment, timing between presses of input buttons 112 can be utilized to generate a timing signature which can be utilized in creating behavior profile 164.

User 116 can provide verification information 150 during authentication process 140. In one embodiment, data 124 can be automatically communicated to content server 160 during authentication process 140. For example, if user 116 selects a pay-per-view content to purchase, data 124 can be transparently conveyed to server 160 as part of the authentication process 140 for the pay-per-view content purchase. Information 150 and data 124 can be communicated as separate data entities or can be conveyed as a single data set. Security engine 162 can evaluate information 150 to determine a match with user credentials 166. When a match does not occur, engine 162 can perform traditional authentication failure procedures (e.g., authentication failure notification).

When a match does occur, engine 162 can assess data 124 against behavior profile 164 to verify user session behavior matches previous session behavior. The assessment can generate a pattern matching score (e.g., confidence score) indicating the likelihood that user 116 can be verified by session behavior. In one instance, the score can be evaluated against a threshold value which can result in an authentication success or failure. Based on authentication result, engine 162 can perform necessary security actions to protect user 116 and/or server 160. In one instance, if a behavior pattern in data 124 is similar to a behavior pattern in profile 164, engine 162 can convey authentication 170 which can authenticate user 116. For example, user 116 can be presented with content 117 and/or user specific pages (e.g., account page, purchase-able content screen, etc).

It should be appreciated that set-top box 111 can support traditional e-commerce sessions within an interface 114 (e.g., Web browser, content guide). For example, set-top box 111 can utilize a two factor authentication scheme during an online shopping session.

In one embodiment, when authentication is successful, interaction data 124 can be utilized to enhance the accuracy of behavior profile 164. In the embodiment, interaction data 124 can be analyzed and behavior patterns can be extracted which can be added to behavior profile 164. That is, data 124 can be utilized to create and/or improve a baseline behavior (e.g., behavior profile) associated with remote control 110.

In another instance, if data 124 is dissimilar to profile 164, engine 162 can execute security actions. In this instance, security actions can include, authentication failure notification, presenting additional credential challenges, and the like. For example, a security question Web page can be presented within interface 114 to verify user identity.

In one embodiment, engine 162 can be present within set-top box 111 (e.g., embodiment 460) permitting localized verification. The embodiment can permit reduced network overhead and improved verification delay.

Drawings presented herein are for illustrative purposes only and should not be construed to limit the invention in any regard. It should be understood that embodiments of remote control 110 can include non-traditional remote controllers including, but not limited to, mobile phones and/or tablet computing devices. Embodiments of set-top box 111 can include, but are not limited to, a converter box, a digital video recorder, a non-specialized computing device executing software able to perform tuning and/or converting functionality, and the like.

It should be appreciated that any combination of interaction data 124 can be utilized in identifying user 116. It should be understood that data 124 can be utilized at any time during an e-commerce session to verify user identity. For instance, data 124 can be communicated in response to user 116 initiating an e-commerce transaction (e.g., purchase). It should be understood that process 140 can be performed at the beginning of an e-commerce session, at purchase time, and the like. The disclosure can be utilized to assist in user validation with any e-commerce related transaction including, but not limited to, account setting changes, payment information changes, and the like.

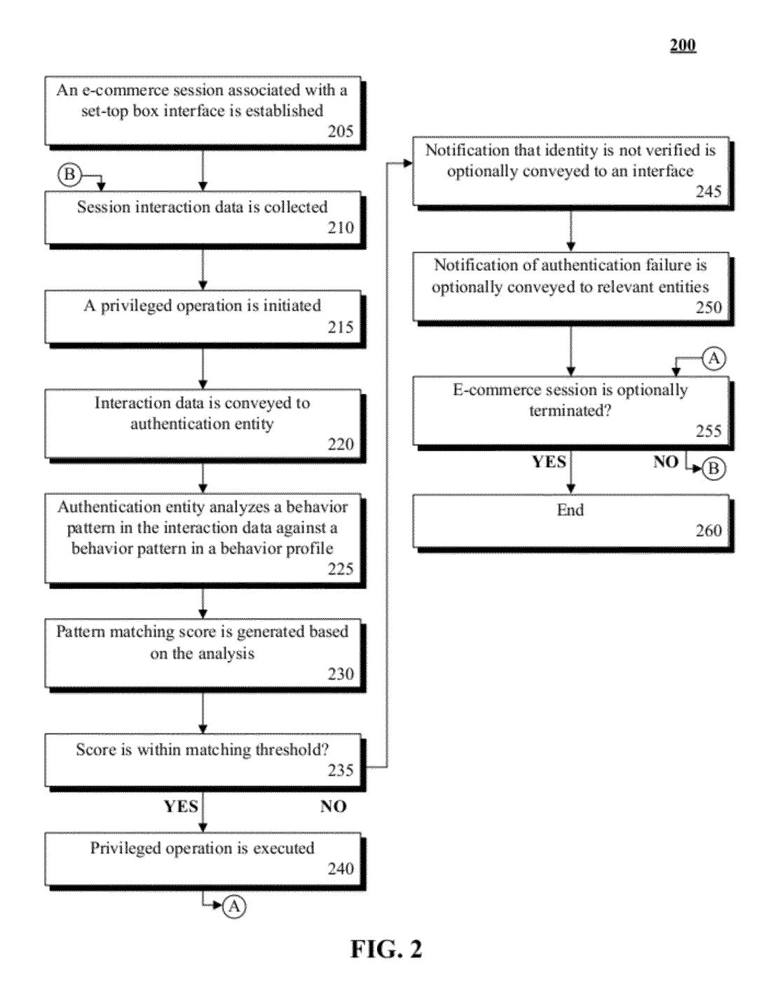

FIG. 2 is a schematic diagram illustrating a method 200 for transparently verifying user identity during an e-commerce session based on set-top box remote control interaction behavior in accordance with an embodiment of the inventive arrangements disclosed herein. Method 200 can be performed in the context of processes 105, 140 and/or system 300. In method 200, a user can be verified as part of a two factor authentication process utilizing user behavior collected during an e-commerce session. In method 200, program (e.g., program code 334) within a set-top box can perform steps 205-220. A security functionality (e.g., security engine 360) can perform steps 225-255. Session interaction data such as button selection can be collected as the user interacts with content (e.g., presented within a display). Interaction data can be leveraged to help identify the user and decrease unauthorized activities (e.g., e-commerce fraud). For example, during a purchase transaction, user identity can be verified by analyzing session behavior against an established user behavior profile.

In step 205, an e-commerce session associated with a set-top box can be established. The e-commerce session can be established in one or more traditional and/or proprietary manners. For example, the e-commerce session can be established in response to a user authenticating via a login screen of a social networking Web site. In step 210, session interaction data can be collected. In one instance, interaction data can be selectively collected based on device. For example, when multiple set-top boxes are present within a user's home, a primary set-top box can be determined and interaction data can be collected from the primary set-top box. In step 215, a privileged operation can be initiated. A privileged operation can include any user initiated action associated with a user account.

In step 220, interaction data can be conveyed to an authentication entity. In step 225, a behavior pattern in the interaction data can be analyzed against a behavior pattern in a behavior profile by the authentication entity. In step 230, a pattern matching score can be generated based on the analysis. The score can be a numerical value, non-numerical value, and the like. For example, the score can be a percentage value indicating the confidence at which the behavior pattern in the interaction data is similar to the behavior pattern in the behavior profile. In step 235, it is determined if the score is within a matching threshold. The matching threshold can be an administrator established value, system determined value, and the like. If it is determined at step 235 that the score is within the matching threshold, the method can continue to step 240 else proceed to step 245. In step 240, the privileged operation can be executed. In step 245, a notification that user identity cannot be confirmed can be optionally conveyed to an appropriate interface. In step 250, a notification of authentication failure can be optionally conveyed to relevant entities. For instance, an email notification can be conveyed to an account manager of the Web site alerting the manager of an authentication failure associated with a user account. In step 255, if the e-commerce session is optionally terminated, the method can continue to step 260, else proceed to step 210. In one embodiment, site protection program code can automatically terminate the e-commerce session (e.g., logging the user out of the account and locking the account). In step 260, the method can end.

Drawings presented herein are for illustrative purposes only and should not be construed to limit the invention in any regard. Step 210-255 can be continuously executed for the e-commerce session enabling user behavior patterns to be collected and evaluated to assist in positively identifying user identity. In one embodiment, behavior can be continually collected and analyzed to establish various behavior baselines. For example, baselines for various activities such as “channel surfing” (e.g., changing channels rapidly) can be established.

The disclosure can be arbitrarily sophisticated enabling flexible and robust user verification capabilities. In one embodiment, a behavior pattern in interaction data can be evaluated against behavior patterns in different behavior profiles based on criteria (e.g., time of day, room). It should be appreciated that method 200 can be a portion of an authentication scheme. It should be understood that, steps 210-255 can be performed in parallel or in serial. Further, the method 200 can be performed in real-time or near real-time.

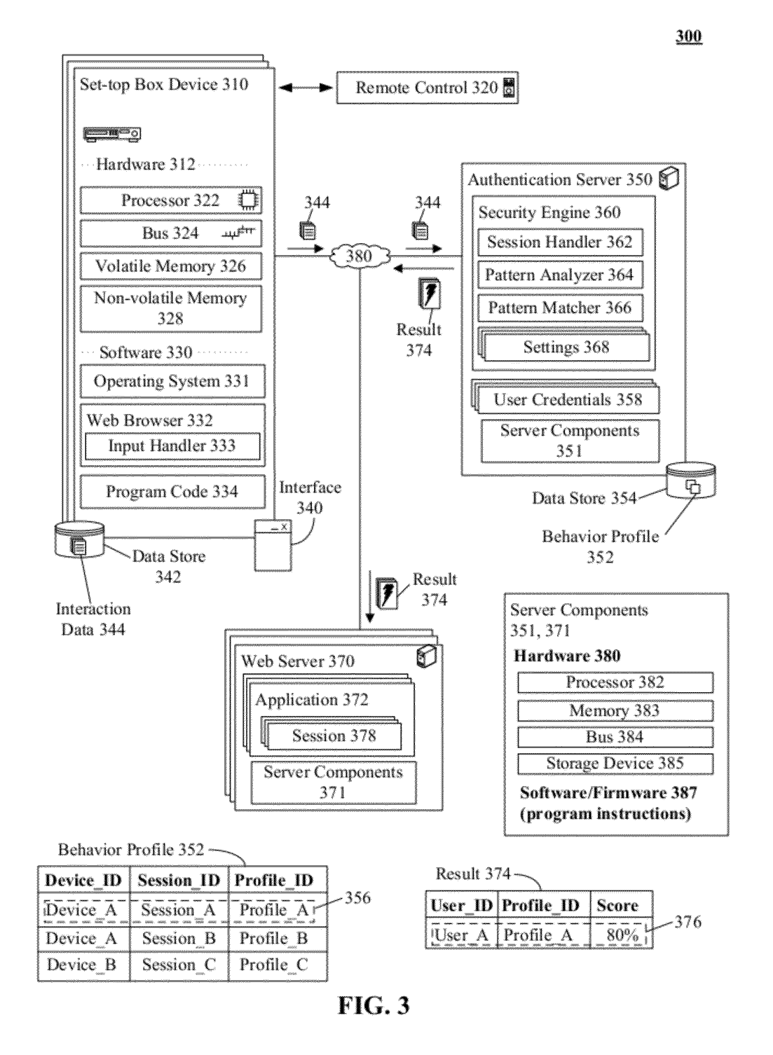

FIG. 3 is a schematic diagram illustrating a system 300 for transparently verifying user identity during an e-commerce session based on set-top box remote control interaction behavior in accordance with an embodiment of the inventive arrangements disclosed herein. System 300 can be present in the context of processes 105, 140 and/or method 200. System 300 can illustrate an e-commerce session conducted through set-top box 310. For example, set-top box 310 can be a component of a media center device permitting online shopping capabilities. In system 300, a security engine 360 can permit enhanced user authentication utilizing set-top box behavior pattern matching. Input handler 333 can collect interaction data 344 via interface 340. Interaction data 344 can be communicated via network 380 to authentication server 350. Server 350 can utilize user credentials 358 (e.g., login information) in conjunction with behavior profile 352 to verify user identity. Server 350 can communicate the result 374 of user identity verification to application 372.

In one instance, handler 333 can communicate interaction data 344 to relevant entities via an Asynchronous Javascript and Extensible Markup Language (AJAX) procedure. In the instance, an Extensible Markup Language HyperText Markup Language (XMLHTTP) procedure can be utilized (e.g., by Web browser 332) to communicate data 344 in real-time or near real-time.

As used herein, interface 340 can be a hardware element associated with a display such as a television or set-top box. Interface 340 can be a visual display permitting the presentation of content (e.g., content 117). Interface 340 can include, but is not limited to, Liquid Crystal Display (LCD), Light Emitting Diode (LED) display, resistive technologies, capacitive technologies, surface acoustic wave technologies, and the like. In one embodiment, interface 340 can present a content guide. In another embodiment, interface 340 can present a Web-enabled application with e-commerce session capabilities. As set-top box 310 collects interaction data 344, set-top box 310 can store data 344 within data store 342.

Web browser 332 can be for retrieving, presenting, and traversing information resources on the World Wide Web. An information resource can be identified by a Uniform Resource Identifier (URI) and can be a Web page, image, video, or other digital content. Browser 332 can include, but is not limited to, input handler 333, renderable canvas (not shown), a rendering engine, and the like. Browser 332 can be, for example, FIREFOX®, GOOGLE CHROME™, SAFARI®, and OPERA™ (Firefox® is a registered trademark of Mozilla Foundation in the United States; Google Chrome™ is a trademark of Google Inc. in the United States; Safari® is a registered trademark of Apple Inc. in the United States; and Opera™ is a trademark of Opera Software ASA in the United States).

Input handler 333 can be a software component for detecting and logging remote control 320 based user interaction. Set-top box 310 can utilize handler 333 to detect user interaction associated with input button order selection, input button actuation timing, and the like, using remote control 320. For example, handler 333 can utilize traditional functionality (e.g., APIs) to capture user interaction with remote control 320. Handler 333 can store, within data store 342 as interaction data 344, user interaction with remote control 320 and associated with a session 378.

Authentication server 350 can be a hardware/software element for processing interaction data 344 and producing result 374. Server 350 can include a set of server components 351, which includes hardware 380 and software/firmware 387. Authentication server 350 can have built-in redundancy, high performance, and support for complex database access. Server 350 can include, but is not limited to, security engine 360, data store 354, user credentials 358, and the like. In one instance, server 350 can be associated with a middleware software entity. In the instance, server 350 can be an IBM WEBSPHERE COMMERCE® server (WEBSPHERE® is a registered trademark of International Business Machines Corporation in the United States). It should be appreciated that server 350 can be a distributed computing element. For example, server 350 functionality can be a software-as-a-service (SaaS) Web-enabled service.

Engine 360 can be a hardware/software entity able to authenticate a user based on behavior profile 352. Engine 360 can include, but is not limited to, session handler 362, pattern analyzer 364, pattern matcher 366, settings 368, user credentials 358, and the like. In one instance, engine 360 functionality can be encapsulated within an application programming interface (API). In one embodiment, engine 360 can be a network element within a service oriented architecture (SOA). For example, engine 360 can function as a Web service transparently performing authentication actions for application 372. In one embodiment, engine 360 can be a component of server 370.

Session handler 362 can be a hardware/software component for tracking e-commerce sessions. Handler 362 functionality can include session commencement, session termination, session tracking, device tracking, user account identification, and the like. Engine 360 can utilize handler 362 to associate interaction data 344 with user credentials 358. In one instance, handler 362 can track sessions across multiple interactions, multiple applications 372, and the like. In the instance, handler 362 can utilize hardware and/or software information including, but not limited to, an identifier of a processor 322, a class of processor 322, a version of an operating system 331, a version of browser 332 (e.g., major, minor), browser codename, cookies, Internet Protocol (IP) address subnet, platform (e.g., operating system 331), user agent, system language, and the like. In one configuration of the instance, information can be associated with weighting values permitting rapid detection of set-top box 310 usage. For example, IP address subnet can have a positive weighting allowing device network location to quickly identify set-top box 310 when multiple set-top boxes are associated with a user (e.g., content service subscriber). In one embodiment, handler 362 can request interaction data 344 for a current e-commerce session (e.g., session 378). In another embodiment, handler 362 can request interaction data 344 for a historic e-commerce session.

Pattern analyzer 364 can be a hardware/software entity for evaluating behavior patterns associated with interaction data 344. Analyzer 364 functionality can include, but is not limited to, pattern detection, data mining, data scrubbing, and the like. In one embodiment, analyzer 364 can be used to select specific types of interaction data 344 for evaluation. For example, analyzer engine 360 can utilize analyzer 364 to select gesture behaviors to be examined by matcher 366. In one embodiment, analyzer 364 can heuristically determine behavior characteristics of importance. For example, although many users can have similar remote control 320 interaction patterns, users' idiosyncrasies can be determined which can uniquely identify the user. In one instance, analyzer 364 can identify and catalog idiosyncrasies which can be utilized to quickly validate user identity. For example, a behavior “fingerprint” can be created for each user permitting rapid assessment of user authorization.

Pattern matcher 366 can be a hardware/software component for confirming user identity based on data 344 and profile 352. Matcher 366 functionality can include, but is not limited to, pattern matching, partial matching, pattern recognition, and the like. In one instance, matcher 366 can produce a pattern matching score which application 372 can utilize to verify user identity. In one embodiment, matcher 366 can generate result 374 which engine 360 can convey to application 372. In one instance, authorization can be determined within matcher 366 based on a pattern matching ruleset. In the instance, matcher 366 can evaluate a pattern matching score against one or more thresholds (e.g., within a ruleset) to confirm a user identity.

Settings 368 can be one or more configuration options for establishing the behavior of system 300 and/or engine 360. Settings 368 can include, but are not limited to, session handler 362 options, pattern analyzer 364 parameters, pattern matcher 366 configuration settings, profile 352 settings, and the like. In one embodiment, engine 360 can utilize settings 368 to specify security protocols which can protect system 300. For example, settings can specify encryption schemes which can be employed by set-top box 310, server 350, and server 370 to secure data 344 and/or result 374 in transit.

Behavior profile 352 can be a data set including user remote control 320 behavior patterns associated with an e-commerce session and/or a user account. Behavior profile 352 can include, but is not limited to, a device identifier, a session identifier, a user profile, a user account, and the like. Profile 352 can include a baseline behavior characterization, a non-baseline characterization, and the like. For instance, profile 352 can support multiple profiles for a user based on device (e.g., multiple set-top boxes). Device to profile tracking can be enabled utilizing entry 356 which can link a device identifier (e.g., Device_A) to a profile identifier (e.g., Profile_A). It should be appreciated that profile 352 can be arbitrarily complex permitting support of any behavior profile to be established.

Result 374 can be a data set associated with data 344 and profile 352 evaluation. Result 374 can include, but is not limited to, a user identifier, a profile identifier, a score (e.g., confidence score), and the like. For example, result 374 can include data 376 which can provide authentication information for a User_A indicating interaction data matches Profile_A by eighty percent. In one instance, result 374 can conform to a traditional authentication response which can be processed by application 372. For example, when authentication fails, engine 360 can convey an error code within result 374.

Web server 370 can be a hardware/software element for executing application 372. Server 370 can include a set of server components 371, which includes hardware 380 and software/firmware 387. Web server 370 can have built-in redundancy, high performance, and support for complex database access. Server 370 can include, but is not limited to, application 372, application 372 settings, and the like. In one instance, server 370 can be associated with an IBM WEBSPHERE APPLICATION® server (WEBSPHERE® is a registered trademark of International Business Machines Corporation in the United States). Server 370 can include multiple servers which can be geographically distributed.

Application 372 can be a Web-based application permitting one or more privileged operations to be performed. Application 372 can include session 378 which can be associated with browser 332. In one instance, session 372 can be an e-commerce session. Application 372 can be a client-based application (e.g., rich internet application), server based application, and the like. For example, application 372 can be a business-to-business e-commerce application permitting electronic fund transfers.

Each of the server components 351, 371 can include one or more processors 382, one or more computer-readable memories 383, and one or more computer-readable tangible storage devices 385, which are connected via a bus 384. Within each of the servers 350, and 370, program instructions (e.g., software/firmware 387) can be stored on at least one of the one or more storage devices 385 for execution by at least one of the one or more processors 382 via at least one of the one or more memories 383. Software/firmware 387 can include any one or more of application 372, security engine 360, session handler 362, pattern analyzer 364, and pattern matcher 366.

Set-top box device 310 can be an electronic device having remote management capabilities via remote control 320. Device 310 can include hardware 312, software 330, firmware, and the like. Hardware 312 can include, but is not limited, processor 322, bus 324, volatile memory 326, non-volatile memory 328, data store 342, and the like. Software 330 can include operating system 331, browser 332, interface 340, and the like. Device 310 can include, but is not limited to, a mobile phone, a laptop, a tablet computing device, a desktop computer, a portable media player, a portable gaming system, and the like. It should be appreciated that Web browser 332 can be an optional component and can be substituted with an application interface with e-commerce capabilities.

Interface 340 can be a user interactive component permitting interaction with browser 332. Interface 340 can present Web browser 332, an e-commerce application, and the like. Interface 340 capabilities can include a graphical user interface (GUI), voice user interface (VUI), mixed-mode interface, and the like. Interface 340 can be communicatively linked to device 310.

Data stores 342, 354 can be a hardware/software component able to store data 344 and behavior profile 354, respectively. Data stores 342, 354 can each be a Storage Area Network (SAN), Network Attached Storage (NAS), and the like. Data stores 342, 354 can each conform to a relational database management system (RDBMS), object oriented database management system (OODBMS), and the like. Data stores 342, 354 can be communicatively linked to computing device 310 and server 350, respectively, in one or more traditional and/or proprietary mechanisms.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but are not limited to, bus, star, mesh, and the like. Network 380 types can include, but are not limited to, Local Area Network (LAN), Wide Area Network (WAN), Virtual Private Network (VPN) and the like.

Drawings presented herein are for illustrative purposes only and should not be construed to limit the invention in any regard. The disclosure can be associated with any traditional and/or proprietary authentication scheme including, but not limited to, private key cryptography, public key cryptography, and the like. It should be appreciated that system 300 can represent one embodiment of the disclosure and actual implementation characteristics can vary. System 300 can be a component of a networked computing architecture, a distributed computing environment, a cloud computing environment, and the like.

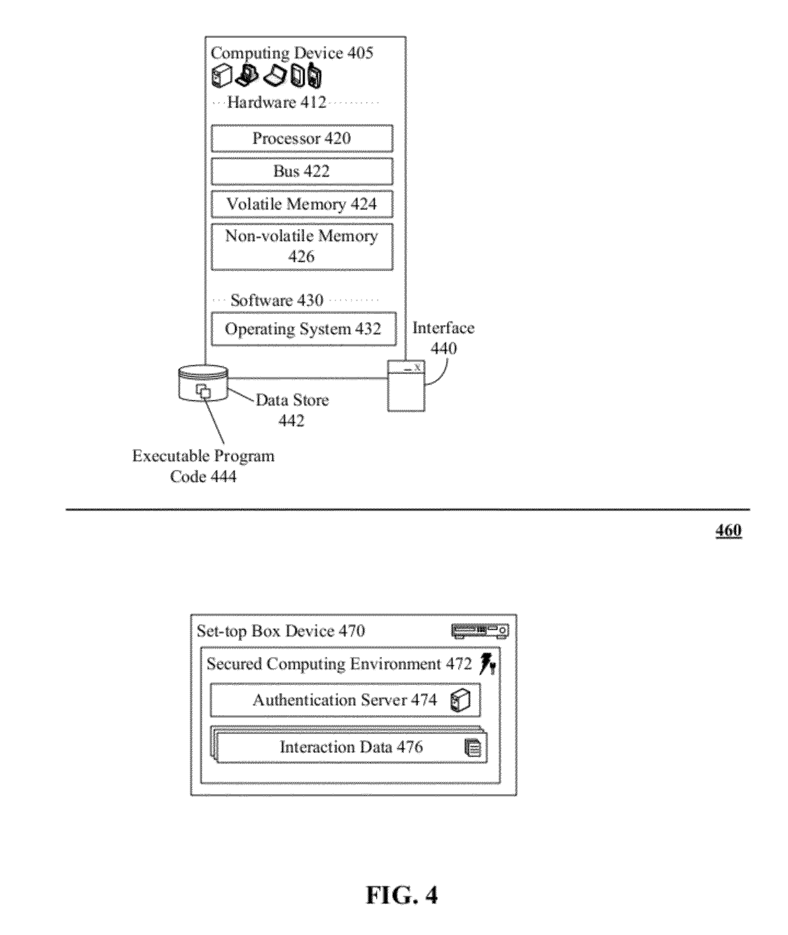

FIG. 4 is a schematic diagram illustrating an exemplary computing device 405 and an embodiment 460 for a set-top box for transparently verifying user identity during an e-commerce session based on set-top box remote control interaction behavior in accordance with an embodiment of the inventive arrangements disclosed herein.

Computing device 405 can be a programmable machine designed to sequentially and automatically carry out a sequence of arithmetic or logical operations. Device 405 can include hardware 412, software 430, firmware, and the like. Hardware 412 can include, but is not limited processor 420, bus 422, volatile memory 424, non-volatile memory 426, data store 442, and the like. Software 430 can include operating system 432, interface 440, and the like. Software 430 can include executable program code 444 stored within machine readable data store 442. Machine readable data store 442 can include one or more computer readable tangible storage devices, at least one of which stores program code 444. Executable program code 444 can be one or more algorithms for performing operations described within the disclosure. Executable program code 444 can be executed within operating system 432, firmware, and the like. Device 405 can include, but is not limited to, a server computing device, a network computing element, and the like. Device 405 can be an example of server 350 and/or server 370.

Embodiment 460 can be a set-top box device 470 executing a secured computing environment 472. Set-top box device 470 can include, but is not limited to, secured computing environment 472, firmware, display, and the like. Environment 472 can be an execution platform permitting the execution of trusted program code. Environment 472 can include, but is not limited to, authentication server 474, interaction data 476, and the like. In one instance, server 474 can include a security engine (e.g., security engine 360) able to verify user identity. In the instance, the security engine can communicate with a remotely located server to obtain a behavior profile for set-top box device 470.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for verifying a user based on data of interactions between the user and a set-top box, the method comprising the steps of:
a set-top box device detecting a user interaction associated with a remote control proximate to the set-top box device;
the set-top box device storing the user interaction within a storage device as user interaction data;
the set-top box device conveying the user interaction data to a remotely located server; and
the set-top box device receiving a response from the remotely located server indicating that a behavior pattern in the interaction data is substantially equivalent to a behavior pattern in previously stored interaction data of a behavior profile, wherein the response verifies the identity of the user.

2. The method of claim 1, further comprising the step of:
the set-top box device requesting a remotely located server to programmatically perform a privileged operation responsive to the receiving, wherein the privileged operation is a user-initiated action associated with a user account.

3. The method of claim 1, further comprising the step of:
before the receiving, the set-top box device identifying and authenticating the user utilizing user-provided verification information.

4. The method of claim 1, wherein the user interaction data includes data of at least one idiosyncratic behavior of the user interaction.

5. The method of claim 1, wherein the user interaction is at least one of a volume adjustment, a channel selection, a fast forward action, a rewind action, a high definition option, a volume preference, a remote control button selection, and a user interaction with a different remote control.

6. The method of claim 1, wherein the user interaction is with a user interface of a Web browser executing within the set-top box device.

7. The method of claim 1, wherein the detecting step is performed by JAVASCRIPT program code in a Web browser executing within the set-top box device.

8. The method of claim 1, wherein the conveying step comprises conveying interaction data to an e-commerce entity via an ASYNCHRONOUS JAVASCRIPT AND EXTENSIBLE MARKUP LANGUAGE (AJAX) action.

9. The method of claim 2, wherein the privileged operation is a single action shopping purchase.

10. The method of claim 2, further comprising the step of:
the set-top box device establishing a baseline behavior associated with a graphical user interface provided by the set-top box device and the user account.

11. A computer system for verifying a user based on data of interactions between the user and a set-top box, said computer system comprising:
one or more processors, one or more computer-readable memories and one or more computer-readable tangible storage devices;
program instructions, stored on at least one of the one or more storage devices for execution by at least one of the one or more processors via at least one of the one or more memories, to detect a user interaction between a user and a remote control device associated with a set-top box executing a graphical user interface, wherein the graphical user interface is an interface of an e-commerce session, and wherein the graphical user interface is associated with a browser session associated with a Web server;
program instructions, stored on at least one of the one or more storage devices for execution by at least one of the one or more processors via at least one of the one or more memories, to store the user interaction within a storage device as user interaction data;
program instructions, stored on at least one of the one or more storage devices for execution by at least one of the one or more processors via at least one of the one or more memories, to verify or refute a user identity using a two factor authentication process by evaluating a behavior pattern in the user interaction data against a behavior pattern in previously stored interaction data contained within a behavior profile specific to the user.

12. The computer system of claim 11, wherein the behavior profile includes a behavioral representation, wherein the behavioral representation specifies a user identity using behavioral biometrics, and wherein the behavioral biometrics are for remote control specific interactions.

13. The computer system of claim 11, wherein the user interaction is at least one of a volume adjustment, a channel selection, a fast forward action, a rewind action, a high definition option, a volume preference, a remote control button selection, and a user interaction with a different remote control.

14. The computer system of claim 11, wherein the program instructions to verify or refute the user identity generate a pattern matching score, wherein the pattern matching score indicates a likelihood that the user identity is confirmed.

15. The computer system of claim 11, wherein the user interaction is a combination of remote control button selections of the remote control.

16. The computer system of claim 11, wherein the user interaction is a volume adjustment operation style associated with the remote control device, wherein the operation style is at least one of a stepwise adjustment and a jump adjustment.

17. The computer system of claim 11, wherein the user interaction is a channel selection operation style associated with the remote control, wherein the operation style is at least one of an increment/decrement selection and a direct tuning selection.

18. The computer system of claim 11, wherein the user identity is associated with a returning customer having previous interaction with an e-commerce application.

19. The computer system of claim 11, wherein the program instructions to verify or refute the user identity identify idiosyncratic behaviors of the user in providing input to the remote control device, and wherein the program instructions to verify further match the idiosyncratic behaviors against corresponding behaviors stored in the behavior profile.

20. A computer program product for verifying a user based on data of interactions between the user and a set-top box, the computer program product comprising:
one or more computer-readable tangible storage devices;
program instructions, stored on at least one of the one or more storage devices, to detect user interaction data associated with a remote control proximate to the set-top box device; program instructions, stored on at least one of the one or more storage devices, to store the user interaction data within a storage device as user interaction data;
program instructions, stored on at least one of the one or more storage devices, to convey the user interaction data to a remotely located server; and
program instructions, stored on at least one of the one or more storage devices, to receive a response from the remotely located server indicating that a behavior pattern in the interaction data is substantially equivalent to a behavior pattern in previously stored interaction data of a behavior profile, wherein the response verifies the identity of the user.

21. The computer program product of claim 20, further comprising:
program instructions, stored on at least one of the one or more storage devices, to request a remotely located server to programmatically perform a privileged operation responsive to the receiving, wherein the privileged operation is a user-initiated action associated with a user account.

22. The computer program product of claim 20, further comprising:
program instructions, stored on at least one of the one or more storage devices, to, before receiving the response, identify and authenticate the user utilizing user-provided verification information.
